(19) United States
(12) Patent Application Publication
(10) Pub. No.: US 2015/0169630 A1
(43) Pub. Date: Jun. 18, 2015

(54) RECOMMENDING AN OUTDOOR ACTIVITY USING A GEOGRAPHIC INFORMATION SYSTEM

(71) Applicant: Google Inc., Mountain View, CA (US)

(72) Inventors: Michael Shynar, Kiryat Ono (IL); Gal Chechik, Los Altos, CA (US); Asaf Zomet, Jerusalem (IL)

(73) Assignee: Google Inc., Mountain View, CA (US)

(21) Appl. No.: 14/075,995

(22) Filed: Nov. 8, 2013

Related U.S. Application Data
(60) Provisional application No. 61/784,982, filed on Mar. 14, 2013.

(51) Int. Cl. G06F 17/30

(52) U.S. Cl. CPC G06F 17/30241

(57) ABSTRACT

Systems and methods for recommending an outdoor activity geographic location are provided. In some aspects, multiple data items that are associated with a recurring time period and a destination geographic location are selected from one or more data repositories. That an outdoor activity for the user is available in the destination geographic location during the recurring time period is determined using information in the selected multiple data items and at least one characteristic of a user of a client computing device. An indication that the outdoor activity is available in the destination geographic location is provided to the client computing device.

### CROSS REFERENCE TO RELATED APPLICATIONS

This application claims priority under 35 U.S. C. §119(e) and the benefit of U.S. Provisional Application No. 61/784,982, filed Mar. 14, 2013, and entitled, “RECOMMENDING AN OUTDOOR ACTIVITY USING A GEOGRAPHIC INFORMATION SYSTEM,” the entire disclosure of which are incorporated herein by reference.

### BACKGROUND

The subject technology generally relates to geographic information systems and, in particular, relates to recommending an outdoor activity using a geographic information system.

Planning an outdoor activity (e.g., a picnic, a hike, etc.) may be challenging for a user, as the user may not be familiar with the geographic area where he/she is located or planning to visit and the most interesting outdoor activity sites in the geographic area. As a result, the user may select a suboptimal site for the outdoor activity. If the user is selecting an outdoor activity site using a mobile phone, for example, while travelling, selecting the outdoor activity site may be even more difficult due to the slower and less convenient searching and browsing capabilities on the mobile phone, rather than a full-size laptop or desktop computer. As the foregoing illustrates, a new approach for recommending an outdoor activity to a user of a computing device may be desirable.

### SUMMARY

In some aspects, the disclosed subject matter relates to a computer-implemented method for recommending an outdoor activity geographic location. The method includes selecting, from one or more data repositories, multiple data items that are associated with a recurring time period and a destination geographic location. The method includes determining, using information in the selected multiple data items and at least one characteristic of a user of a client computing device, that an outdoor activity for the user is available in the destination geographic location during the recurring time period. The method includes providing, to the client computing device, an indication that the outdoor activity is available in the destination geographic location.

In some aspects, the disclosed subject matter relates to a non-transitory computer-readable medium encoded with executable instructions. The instructions include code for selecting, from one or more data repositories, multiple data items that are associated with the recurring time period and the geographic location. The instructions include code for determining, using information in the selected multiple data items, that multiple persons engaged in the type of outdoor activity at the geographic location during the recurring time period. The instructions include code for providing an indication that the geographic location is suitable for the type of outdoor activity during the recurring time period.

In some aspects, the disclosed subject matter relates to a system. The system includes one or more processors and a memory including instructions. The instructions include code for receiving, from a client computing device, a request for an outdoor activity recommendation for a user of the client computing device, the request being associated with a certain time and a geographic region. The instructions include code for selecting multiple types of outdoor activities that are available during a recurring time period in the geographic region, where the recurring time period includes the current time. The instructions include code for determining, based on data stored in a social networking service, interest levels for the user for each type of outdoor activity among at least a first portion of the multiple types of outdoor activities. The instructions include code for selecting, for responding to the request for the outdoor activity recommendation, at least a second portion of the multiple types of outdoor activities based on the determined interest levels. The instructions include code for providing, in response to the request for the outdoor activity recommendation, the at least the second portion of the multiple types of outdoor activities.

Other configurations of the subject technology will become readily apparent from the following detailed description, where various configurations of the subject technology are shown and described by way of illustration. The subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example of a system for recommending an outdoor activity.

FIG. 2 illustrates an example of the client computing device of FIG. 1.

FIG. 3 illustrates an example of the server of FIG. 1.

FIG. 4 illustrates an example of the social data store of FIG. 1.

FIG. 5 illustrates an example of the geographic data store of FIG. 1.

FIG. 6 illustrates an example process by which an outdoor activity geographic location may be recommended.

FIG. 7 illustrates an example process by which a geographic location may be determined to be suitable for an outdoor activity.

FIG. 8 illustrates an example process by which information about available types of outdoor activities may be provided.

FIG. 9 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, certain structures and components are shown in block diagram form in order to avoid obscuring the concepts of the subject technology.

As set forth above, techniques for recommending an outdoor activity to a user of a computing device may be desirable. The subject technology is directed to helping user(s) of computing device(s) find and/or select the best outdoor activity locations for themselves and their companions. Outdoor activities include, for example, picnicking, hiking, biking, boating, kayaking, rafting, etc. Given a set of outdoor activity locations or trails (e.g., outdoor activity locations within 50 miles of New York City) recommendations are based on collecting statistics (based on anonymized and public information from social network(s) or mobile device(s)) of activities in these locations, with emphasis on the current period of the year or another period of the year that is of interest to the user (e.g., picknicking at a lake near New York City may be appealing in June but not in December).

The collected statistics can include a measure of the number of people visiting the geographic location, with an emphasis on the current period of the year. The current period of the year can be the current month (e.g., June of any year) or within a threshold number of days (e.g., 14 days or two weeks) of the current day (e.g., if today is June 1, between May 18 and June 15 of any year). Alternatively, the current period can correspond to any range of dates that includes the current date, for example, the months of February and March, October 20-November 20, between Christmas and New Year's Day, July 4, etc., assuming that the current date falls within the specified ranges. As a result, seasonal attractions (e.g., flower blooming, a nice amount of water in a creek, etc.) can be taken into account.

The collected statistics can include a measure of the number of photographs taken in the geographic location. For example, geocoded photographs collected from users and made public by the users (e.g., in a social networking service) can be used. The measure of the number of photographs can be adjusted to emphasize the current time of year, as discussed above. A large number of photographs can imply a scenic location.

The collected statistics can include a measure of a current number of people visiting the geographic location, to estimate whether the geographic location is already crowded. In addition, the collected statistics can include information about vehicular traffic at or near the geographic location, so that a user selecting a geographic location to visit can avoid traffic jams.

The collected statistics can include social interaction activities with information (e.g., photographs, geographic check-ins and/or geocoded posts) related to the geographic location in a social networking service. A large number of people visiting a geographic location implies popularity. A large number of photographs implies scenic views. A large amount of social interaction (e.g., sharing, commenting, and/or indicating preference) implies memorable or exciting places.

The collected statistics can include a distance (in traffic time or units of distance, e.g., kilometers) relative to the user. For example, a user may prefer to visit a less interesting destination that is closer to his/her home over a more interesting destination that would require a longer travel time.

The collected statistics can include a measure for the type of scenery (e.g., flowers, beach, mountain, desert, etc.) as derived based on content of photograph(s), as determined, for example, by artificial intelligence or machine learning, or based on analysis of the text of post(s), comment(s) or caption(s) of photograph(s).

The subject technology can involve, among other things, an integration of social networking data with geographic data in a mapping service.

Aspects of the subject technology involve determining geographic location(s) of a mobile device and transmitting the determined geographic location(s) to a server. The determined geographic location(s) of the mobile device(s) are stored on the server in an anonymized fashion, such that the determined geographic location(s) cannot be associated with specific mobile device(s) or specific user(s). The determinations of geographic location are known to the user and described in contextual notices provide to the user in plain language, for example, when the user downloads or executes an application. Furthermore, persistent reminders are provided in the user interface of the mobile device that the geographic location is being determined and transmitted. In some aspects, periodic reminders are provided to the user when the user logs into an application (e.g., every tenth login or every thirty days) or electronic messages (e.g., email) are provided to the user to remind him/her of the determinations of the geographic location. The user explicitly and affirmatively provides consent to having the geographic location of his/her mobile device determined and may easily withdraw or revoke such consent at any time via the user interface of the mobile device. Furthermore, the user may remove any geographic location information associated with the mobile device of the user stored by the service (e.g., in a data repository or a server). In some aspects, a privacy dashboard may be provided via the mobile device that allows the user to determine which information about his/her current or past geographic locations is stored by the service or by the mobile device or to remove such information from the service or from the mobile device. Furthermore, all geographic location information is encrypted when transmitted over a network to prevent unauthorized access to the geographic location information.

Aspects of the subject technology involve accessing social networking data of a user, for example, to determine interest of the user in type(s) of outdoor activities, which the user may specific to the social networking service. Optionally, the user may specify some characteristics (e.g., age, gender, fitness level, interest in strenuous activity, etc.) about him/herself to the social networking service. For example, a user may specify, in her registration information with the social networking service, that she is an athletic 25-year-old female who is interested in hiking and rock climbing. However, a user is not required to specify any characteristics about him/herself. The access of the social networking data is known to the user, and the user affirmatively provides his/her login information (e.g., username and password) for the social networking service. The user is provided with persistent reminders that his/her social networking data is being accessed, and the user may revoke his/her consent for the social networking data to be accessed at any time. If the user revokes his/her consent for the social networking data to be accessed, all of the user's social networking data is removed from the server. Furthermore, all social networking information is encrypted when transmitted over a network to prevent unauthorized access to the social networking information.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server.

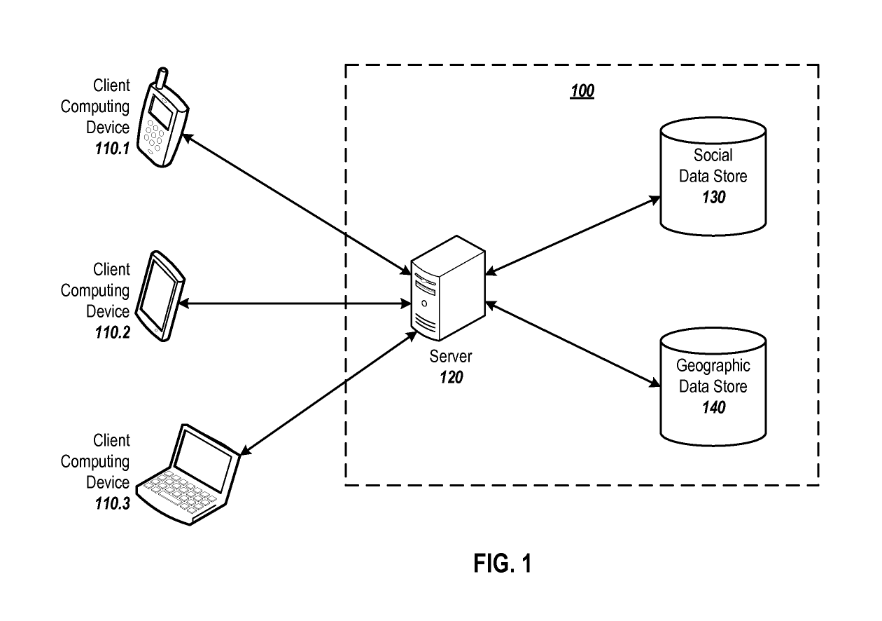

FIG. 1 illustrates an example of a system 100 for recommending an outdoor activity.

As shown, the system 100 includes a server 120, a social data store 130, and a geographic data store 140. While the server 120, the social data store 130, and the geographic data store 140 are illustrated as separate machines, in some aspects, two or more of the server 120, the social data store 130, and the geographic data store 140 can be implemented on the same machine. The server 120 communicates with client computing devices 110.1-3, with the social data store 130, and with the geographic data store 140 via a network. The network can include one or more of the Internet, an intranet, a cellular network, a local area network (LAN), a wide area network (WAN), a virtual private network (VPN), a wired network, a wireless network, etc. While three client computing devices 110.1-3 are illustrated in FIG. 1, the subject technology can be implemented with any number of client computing devices 110.

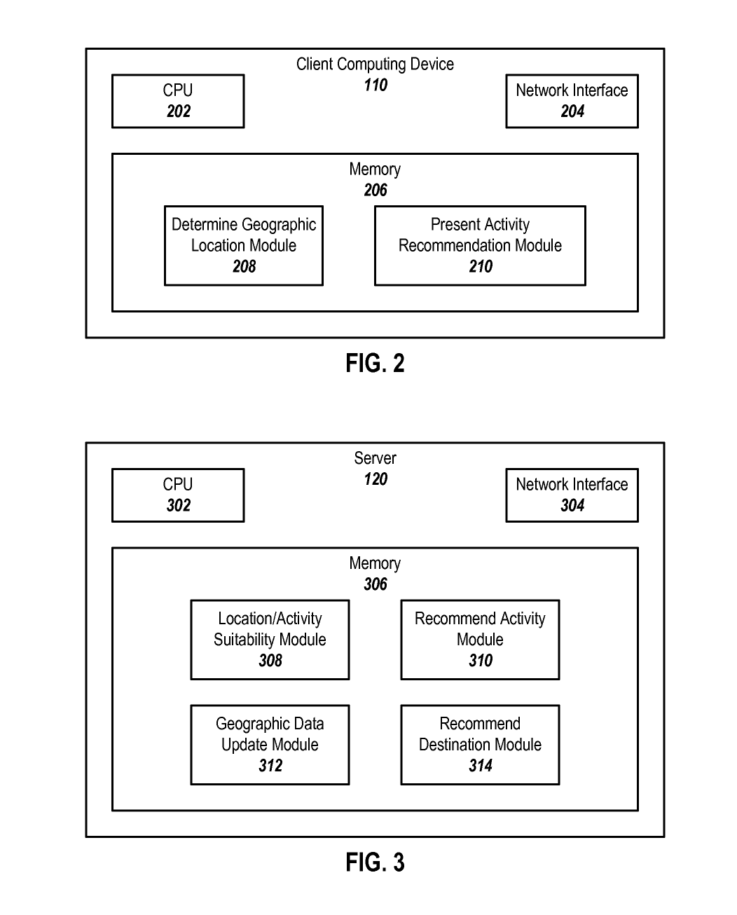

The client computing device(s) 110 may include one or more laptop computer(s), desktop computer(s), mobile phone(s), personal digital assistant(s) (PDA(s)), a personal digital music player(s), tablet computer(s), netbook(s), television(s) with one or more processors embedded therein or coupled thereto, physical machine(s), or virtual machine(s). The client computing devices 110 may include one or more of a keyboard, a mouse, a display, or a touch screen. Some of the client computing devices 110 may also include a web browser configured to display webpages, for example a webpage of an outdoor activity recommendation service. Some of the client computing devices 110 may include a special-purpose application (e.g., a mobile phone or tablet computer application) for accessing the outdoor activity recommendation service. One example client computing device 110 is described in greater detail in conjunction with FIG. 2, below.

The server 120 includes one or more modules for facilitating user interaction with the outdoor activity recommendation service via a browser or a special purpose application executing on the client computing device 110. The server 120 includes one or more modules for managing (e.g., creating or editing) data stored in the social data store 130 or the geographic data store 140. The server 120 may be implemented as a single machine with a single processor, a multi-processor machine, or a server farm including multiple machines with multiple processors. One example of the server 120 is described in more detail in conjunction with FIG. 3 below.

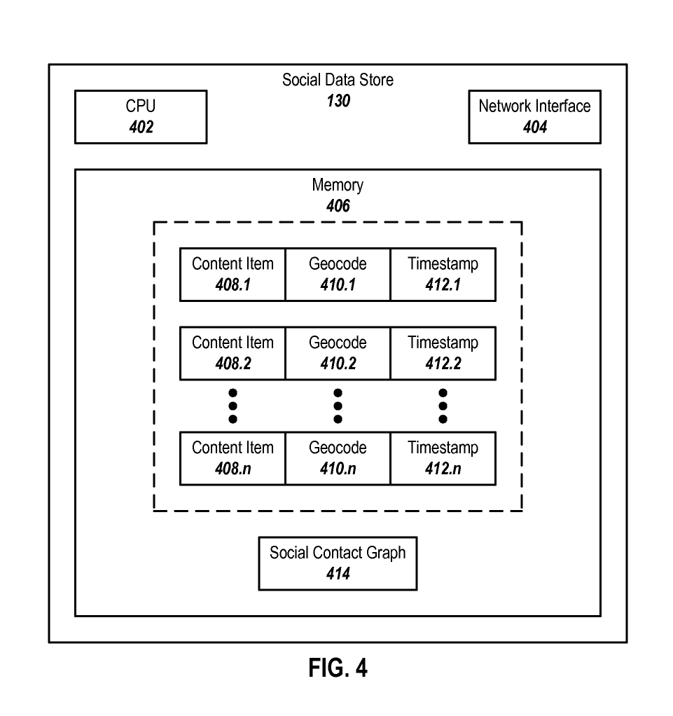

The social data store 130 stores content (e.g., photographs, posts, or geographic check-ins) related to a social networking service. One example of the social data store 130 is described in more detail in conjunction with FIG. 4 below.

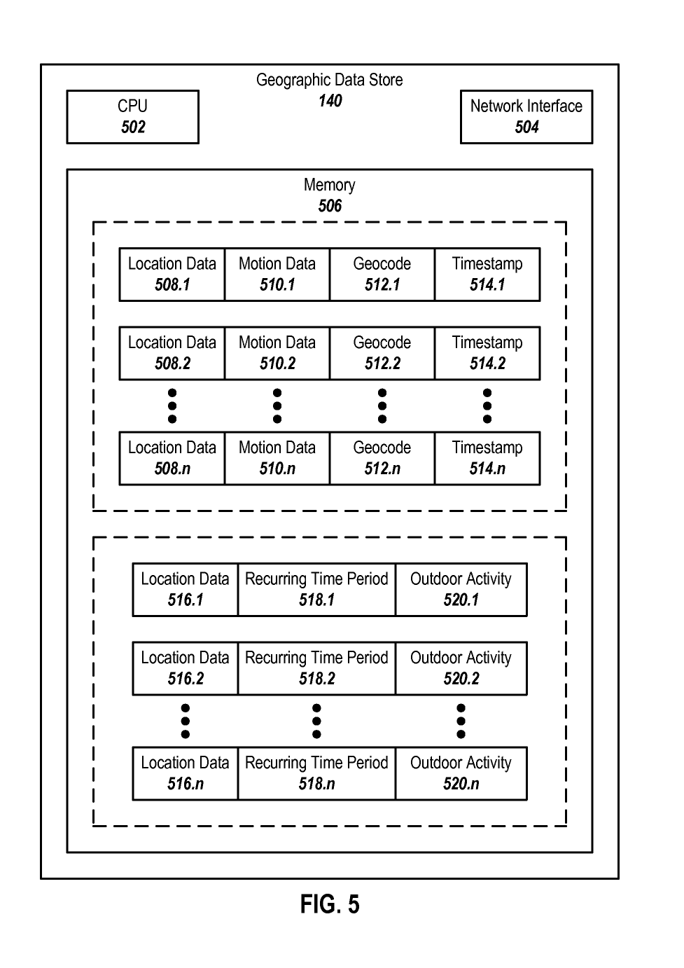

The geographic data store 140 stores data related to geographic locations. The data may be gathered from mobile devices and may include motion information (e.g., speed and direction of motion). Additional information about the geographic locations (e.g., directions and speeds of travel at the geographic locations) may be derived based on data in the geographic data store 140. One example of the geographic data store 140 is described in more detail in conjunction with FIG. 5 below.

In FIG. 1, examples of the subject technology are illustrated in conjunction with a social data store 130 and a geographic data store 140. However, other data stores (e.g., a photograph sharing data store) may also be used in conjunction with the subject technology. Also, some examples of the subject technology can be implemented without one or both of the social data store 130 or the geographic data store 140.

FIG. 2 illustrates an example of a client computing device 110 (e.g., client computing device 110.1, client computing device 110.2, and client computing device 110.3 of FIG. 1).

As shown, the client computing device 110 includes a central processing unit (CPU) 202, a network interface 204, and a memory 206. The CPU 202 includes one or more processors. The CPU 202 is configured to execute computer instructions that are stored in a computer-readable medium, for example, the memory 206. The network interface 204 is configured to allow the client computing device 110 to transmit and receive data in a network, e.g., to communicate with the server 120. The network interface 204 may include one or more network interface cards (NICs). The memory 206 stores data and/or instructions. The memory 206 may be one or more of a cache unit, a storage unit, an internal memory unit, or an external memory unit. As illustrated, the memory 206 includes a determine geographic location module 208 and a present activity recommendation module 210.

The determine geographic location module 208 is configured to determine a current geographic location of the client computing device 110 based on one or more of a global positioning system (GPS) signal, a cellular signal, or a WiFi signal. Upon determining the geographic location of the client computing device 110, the determine geographic location module 208 may provide the determined geographic location along with motion information (e.g., direction, speed, or acceleration of motion) to the server 120. The determine geographic location module 208 can determine the current geographic location of the client computing device 110 to any accuracy (e.g., within 10 meters, within 100 meters, within 1 kilometer, within 10 kilometers, at a determined street address, in a determined city, etc.).

The present activity recommendation module 210 may be implemented as one or more of a mobile phone application, a tablet computer application, a full personal computer application, or a web application (e.g., a webpage) executing within a web browser. The present activity recommendation module 210 is configured to recommend one or more outdoor activities to the user of the client computing device 110 near a specified geographic location (e.g., the current geographic location of the client computing device 110) and a specified time (e.g., the current time). The recommended one or more outdoor activities may be selected based on proximity to the specified geographic location or interests of the user, as provided by the user or as determined based on social networking data of the user.

FIG. 3 illustrates an example of the server 120 of FIG. 1.

As shown, the server 120 includes a central processing unit (CPU) 302, a network interface 304, and a memory 306. The CPU 302 includes one or more processors. The CPU 302 is configured to execute computer instructions that are stored in a computer-readable medium, for example, the memory 306. The network interface 304 is configured to allow the server 120 to transmit and receive data in a network, e.g., to communicate with the client computing devices 110, the social data store 130, or the geographic data store 140. The network interface 304 may include one or more network interface cards (NICs). The memory 306 stores data and/or instructions. The memory 306 may be one or more of a cache unit, a storage unit, an internal memory unit, or an external memory unit. As illustrated, the memory 306 includes a location/activity suitability module 308, a recommend activity module 310, a geographic data update module 312, and a recommend destination module 314.

The location/activity suitability module 308 is configured to determine that multiple data items stored in one or more data repositories (e.g., social data store 130 or geographic data store 140) are associated with a recurring time period (e.g., the month of May) and a geographic location (e.g., ABC Park in DEF City). The location/activity suitability module 308 is configured to determine, based on the multiple data items, that multiple persons engaged in a type of outdoor activity (e.g., picnicking or relaxed strolling) at the geographic location during the recurring time period. The location/activity suitability module 308 is configured to provide an indication that the geographic location is suitable for the type of outdoor activity during the recurring time period.

The recommend activity module 310 is configured to receive, from a client computing device (e.g., client computing device 110), a request for an outdoor activity recommendation for a user (e.g., a user of the client computing device). The request is associated with a certain time (e.g., the current time or a time specified by a user of the client computing device) and a geographic region (e.g., within a threshold distance, e.g., 100 kilometers, of the current geographic location of the client computing device or a geographic region specified by the user of the client computing device). The recommend activity module 310 is configured to determine that one or multiple types of outdoor activities (e.g., jogging at ABC Park, hiking on DEF Mountain, water sports at GHI Beach, etc.) are available during a recurring time period (e.g., the current season of the year) in the geographic region. The recurring time period includes the certain time. The recommend activity module 310 is configured to provide, in response to the request for the outdoor activity recommendation, a portion of the one or multiple types of outdoor activities. The portion may be selected based on known information about the user's interests (e.g., the user is interested in picnicking and water sports, but not in hiking), for example, as stored in a social networking service or as provided by the user to the recommend activity module 310.

The geographic data update module 312 is configured to receive geographic data from a mobile device. The received geographic data is associated with a geocode indicating a geographic location and a timestamp indicating a time. For example, the received geographic data could include motion data (e.g., direction, velocity, and/or acceleration of motion). Based on the motion data, the geographic data update module 312 determines motion path(s) in the geographic location. The determined motion path(s) can correspond to hiking trails, biking trails, meadows where persons stroll, or road(s) where persons travel by vehicle. As a result of the operation of the geographic data update module 312, the geographic data store can include information about movement (e.g., one way streets, two way streets, prevailing speeds, modes of transportation used as determined based on speed, etc.).

The data stored in the geographic data store 130 can include motion data (e.g., received from a mobile device) coupled with a geocode and a timestamp. For example, the motion data could indicate that persons or mobile devices in a geographic location (e.g., a park) travel along a defined path (e.g., a trail) at a walking speed, indicating that the park is used for hiking. Alternatively, the motion data could indicate that persons or mobile devices in the geographic location travel along a defined path at a biking speed, indicating that the park is used for biking. In some examples, the motion data could indicate that persons do not follow certain defined paths in a geographic location, indicating that the location is likely a park for leisurely strolling or playing sports (e.g., soccer, football, basketball, tag, etc.).

The recommend destination module 314 is configured to receive, from a client computing device 110, a request for an outdoor activity recommendation. The request can include an indication of a time (e.g., the current time) and an indication of a geographic location (e.g., the geographic location of the client computing device and the user of the client computing device). The recommend destination module 314 is configured to determine that multiple data items stored in one or more data repositories (e.g., the social data store 130 or the geographic data store 140) are associated with a recurring time period and a destination geographic location. The recommend destination module 314 is configured to determine, based on the multiple data items, that an outdoor activity is available in the destination geographic location during the recurring time period. The recommend destination module 314 is configured to provide, to the client computing device 110 from which the request was received, an indication that the outdoor activity is available in the destination geographic location.

FIG. 4 illustrates an example of the social data store 130 of FIG. 1.

As shown, the social data store 130 includes a central processing unit (CPU) 402, a network interface 404, and a memory 406. The CPU 402 includes one or more processors. The CPU 402 is configured to execute computer instructions that are stored in a computer-readable medium, for example, the memory 406. The network interface 404 is configured to allow the social data store 130 to transmit and receive data in a network, e.g., to communicate with the server 120. The network interface 404 may include one or more network interface cards (NICs). The memory 406 stores data and/or instructions. The memory 406 may be one or more of a cache unit, a storage unit, an internal memory unit, or an external memory unit. As illustrated, the memory 406 includes a data structure storing content items 408.1-n, where each content item 408.k is associated with a geographic code (geocode) 410.k and a timestamp 412.k, and a social contact graph 414.

The content items 408.1-n can include any content stored in a social networking service, for example, posts, geographic check-ins, photographs, videos, etc. All or a portion of the content items 408.1-n can be associated with geocodes 410.1-n or timestamps 412.1-n. The geocode 410.k of a content item 408.k can indicate the geographic location where the content item 408.k was created or from where the content item 408.k was uploaded to the social networking service. The geocode 410.k can be created by a machine (e.g., a camera or a mobile phone) creating the content item 408.k or later added by a user (for example, via an “add location” feature in a social networking service). The timestamp 412.k of a content item 408.k can indicate the time when the content item was created or uploaded to the social networking service. The timestamp 412.k can be created by a machine (e.g., a camera or a mobile phone) creating the content item 408.k or later added by a user (for example, via an “add time” feature in a social networking service).

The social contact graph 414 includes a graph of social contacts (e.g., friends) of users in a social networking service or indications of membership of users of the social networking service in groups of the social networking service (e.g., groups dedicated to activities (e.g., “ABC County Tennis Players”), alumni groups (e.g. “DEF University Alumni”), or professional groups (e.g., “ABC County Accountants Association”)). In some examples, the social contact graph 414 can be used to determine interests of a user (e.g., if a user has 50 social contacts, 25 of whom indicated to the social networking service that they play tennis, and is a member of a social networking group dedicated to tennis, the user is likely to be interested in tennis). Alternatively, the user can indicate his interests directly to the social networking service (e.g., when registering with the social networking service).

FIG. 5 illustrates an example of the geographic data store 140 of FIG. 1.

As shown, the geographic data store 140 includes a central processing unit (CPU) 502, a network interface 504, and a memory 506. The CPU 502 includes one or more processors. The CPU 502 is configured to execute computer instructions that are stored in a computer-readable medium, for example, the memory 506. The network interface 504 is configured to allow the social data store 130 to transmit and receive data in a network, e.g., to communicate with the server 120. The network interface 504 may include one or more network interface cards (NICs). The memory 506 stores data and/or instructions. The memory 506 may be one or more of a cache unit, a storage unit, an internal memory unit, or an external memory unit. As illustrated, the memory 506 includes a data structure storing location data 508.1-n, where each location data item 508.k is coupled with motion data 510.k, a geographic code (geocode) 512.k and a timestamp 514.k, and a data structure storing location data 516.1-n, where each location data item 516.k is associated with a recurring time period 518.k and an outdoor activity 520.k. In some examples, one or more of the motion data 510.k, the geocode 512.k, or the timestamp 514.k for the location data item 508.k can be blank. In some examples, one or more of the recurring time period 518.k or the outdoor activity 520.k for the location data item 516.k can be blank, or the recurring time period 518.k or the outdoor activity 520.k can be blank.

As shown, in one data structure of location data 508.1-n, each location data item 508.k is associated with motion data 510.k, a geocode 512.k, and a timestamp 514.k. The location data 508.k can include a name of a geographic area and an indication of the geographic boundaries of the geographic area (e.g., Central Park in New York City and an indication of the geographic boundaries of Central Park). The motion data 510.k can include a speed and a direction of motion. The geocode 512.k can correspond to a geographic position (e.g., a latitude and a longitude). The timestamp 514.k can correspond to a specified time (e.g., 12:30:32 PM EST on Mar. 7, 2013). The location data 508.1-n and the associated information can correspond to anonymized location data received from mobile device.

In some implementations, information can be derived based on the location data 508.1-n. The derived information can include, for example, speeds and directions of travel at different times. The derived information can be used to determine traffic patterns and travel speeds, and can be used to determine a mode of transportation (e.g., foot, bicycle, car, train, etc.) that is likely being used. In some examples, after multiple location data items 508.1-n associated with a specified geographic area (e.g., a city park) are stored in the memory 508, patterns can be determined. The patterns can correspond to multiple people travelling along the same paths at the same speeds. Based on the speeds, these paths can be determined to be hiking or biking trails or roads for travel by car. The patterns can correspond to people walking at slower speeds or staying in one position for an extended period. These patterns can correspond to a meadow in which people are strolling or picknicking. The patterns can correspond to people running around not along a predetermined trail. These patterns can correspond to a location in which people play sports games (e.g., American soccer, American football, baseball, basketball, or tag).

In some implementations, the information derived above may be stored in a data structure associating location data 516.1-n with recurring time periods 518.1-n and outdoor activities 520.1-n, where each location data item 516.k is associated with a recurring time period 518.k and an outdoor activity 520.k that is typically done in the location corresponding to the location data 516.k during the recurring time period 520.k. The location data 516.k can include a name of a geographic area and an indication of the geographic boundaries of the geographic area (e.g., Golden Gate Park in San Francisco, Calif. and an indication of the geographic boundaries of Golden Gate Park). The recurring time period 518.k can be a time period that recurs with any frequency for example annually (e.g., the month of July, April 15-October 15, etc.) or weekly (e.g., Fridays, weekends, etc.). The outdoor activity 520.k can be any outdoor activity, for example, picknicking, strolling, hiking, biking, boating, swimming, ice skating, playing a sports game, etc.

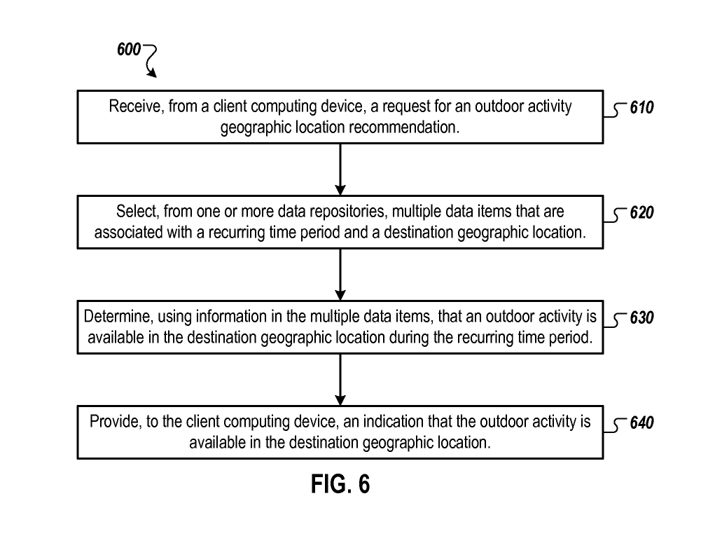

FIG. 6 illustrates an example process 600 by which an outdoor activity geographic location may be recommended.

The process 600 begins at step 610, where a server (e.g., server 120 via operation of the recommend destination module 314) receives, from a client computing device (e.g., client computing device 110), a request for an outdoor activity geographic location recommendation. To provide the request for the recommendation to the server, a user could access a webpage for providing recommendations for outdoor activity geographic locations or access a special-purpose application (e.g., a mobile phone or tablet computer application) for providing recommendations for outdoor activity geographic locations. The user of the client computing device can specify a geographic location to be associated with the request, for example, a current geographic location of the client computing device or a geographic location entered by the user.

In step 620, the server selects from one or more data repositories (e.g., the social data store 130, the geographic data store 140, or one or more other data repositories), multiple data items that are associated with a recurring time period and a destination geographic location.

The recurring time period can recur once per year or once per any other length of time (e.g., once per week, once per month, etc.). Alternatively, the recurring time period can be an irregularly recurring time period. According to some examples, the recurring time period includes the current time. For example, if today is Friday, March 8, the recurring time period could correspond to the day of the week Friday, the month of March, March 7-14, Fridays in the months of March and April, etc.

The recurring time period can be specified by the user of the client computing device in the request received from the client computing device. Alternatively, the recurring time period can be automatically determined based on a current time or an input time provided by the user (e.g., a user may be searching for summertime activities during the winter months to satisfy the user's curiosity or to plan a summer trip). For example, the recurring time period can recur annually. The recurring time period can correspond to a current month of the year (e.g., March), or to a time period between a first threshold number of days (e.g., 7 days) before a current date to a time period a second threshold number of days (e.g., 8 days) after the current date (e.g., if today is March 15, the time period can correspond to March 7-March 22). In some examples, the first threshold number of days is equal to the second threshold number of days (e.g., both are 10 days).

The destination geographic location could be a geographic location within a geographic region specified by the user of the client computing device in the request. For example, the user can specify that the user is interested in outdoor activities within a threshold radius (e.g., 100 kilometers) of his/her current location as determined by the client computing device, within the threshold radius of a geographic location in which the user is interested (e.g., within 100 kilometers of Pittsburgh, Pa.) or within a defined geographic region (e.g., within the State of Rhode Island). The destination geographic location can be any geographic location within the region specified at the client computing device. For example, if the client computing device specifies that the region is San Francisco, Calif., the destination geographic location can be Golden Gate Park, Alamo Square Park, Baker Beach, Twin Peaks, or any other outdoor activity location in San Francisco.

The multiple data items associated with the recurring time period and the destination geographic location can include a number of people visiting the destination geographic location during a specified time (e.g., weekends) within the recurring time period (e.g., the month of May). For example, if a picnic destination is very popular during weekends in May, a visitor may have difficulty finding a free picnic table or a parking spot, and the picnic destination may not be recommended in May. However, the picnic destination may be recommended to a user looking for an outdoor activity during a weekday, when the picnic destination may be less crowded. The multiple data items can include a number of photographs taken in the destination geographic location during the recurring time period. A large number of photographs can be indicative of a place with interesting or beautiful scenery. The multiple data items can include a number of photographs taken in the destination geographic location during the recurring time period that were interacted with (e.g., re-shared, indicated a preference for, or commented on) via a social networking service or a photograph sharing service. A large number of interactions with photographs in the social networking service may be indicative of a memorable or exciting geographic location to visit during the recurring time period.

In step 630, the server determines, using information in the multiple data items, that an outdoor activity is available in the destination geographic location during the recurring time period. If the recurring time period includes the current time, the server can determine that the outdoor activity is available in the destination geographic location at the current time. In some examples, the server determines that a data structure in a data repository indicates that an outdoor activity is typically engaged in at a geographic location corresponding to the location data (e.g., as shown in FIG. 5, outdoor activity 520.1 (e.g., swimming) is typically engaged in at location data 516.1 (e.g., GHI Beach) during recurring time period 518.1 (e.g., June 15-August 31)).

In some implementations, the determination of step 630 can also be based on at least one characteristic of a user of the client computing device. The characteristic of the user can be a geographic location of the user of the client computing device as determined by the client computing device. (The user and the client computing device are typically in the same geographic location when the user is using the client computing device.) The characteristic of the user can correspond to an interest of the user in an outdoor activity. For example, if the user is interested in mountain biking, mountain biking trails can be recommended to the user. The interests of the user can be specified directly by the user, in registering for the outdoor activity recommendation service or for a social networking service that shares data with the outdoor activity recommendation service. Alternatively, the interests of the user can be determined automatically, for example, based on a social graph (e.g., social contact graph 414) associated with a social networking service. For example, a user may have never specified that he/she is interested in hiking. However, the user may be a member of a social network group dedicated to hiking or have at least a threshold number (e.g., 10) of social contacts who have specified that they are interested in hiking Under these circumstances, the user is likely to be interested in hiking, and hiking outdoor activity locations (e.g., hiking trails) may be recommended for the user.

In some implementations, the characteristic of the user of the client computing device can include an age, a gender, a fitness level, or a desired activity strenuousness level of the user. For example, a healthy 20-year-old man who is interested in strenuous activity may be recommended to take a high speed whitewater rafting adventure. However, a walk in a city park may be more appropriate for a family with small children. If a user is interested in activities for a family, the ages of the children in the family, if known, can be a factor used to recommend activities or activity geographic locations.

In some implementations, the multiple data items include a type of scenery at the geographic location during the recurring time period, and the characteristic of the user includes an interest level of the user in the type of scenery. For example, if a user is interested in scenery with flowers, a geographic location that has flowers blooming during the recurring time period can be recommended to the user.

In some cases, the server can determine, based on information received from one or more mobile devices, an estimated current number of people visiting the destination geographic location. Determining that the outdoor activity is available in the destination geographic location can be based on the estimated current number of people visiting the destination geographic location. In some examples, if a WiFi network is available in the destination geographic location, the number of people visiting the destination geographic location can be determined based on a number of devices accessing the WiFi network. (For example, if 10% of visitors to a park access the park's WiFi network and 20 people are accessing the WiFi network, there are approximately 200 people presently visiting the park.) In some implementations, one or more mobile devices transmit indicia of their geographic locations to the server, allowing the server to determine a number of mobile devices, and, therefore, an estimated number of people, present at the destination geographic location.

In some implementations, the server can determine an estimated vehicular traffic between a geographic location specified by the client computing device (e.g., the current geographic location of the client computing device or a geographic location indicated by the user of the client computing device) and the destination geographic location. Determining that the outdoor activity is available in the destination geographic location can be based on the estimated vehicular traffic. For example, if the user is able to reach the destination geographic location quickly, visiting the destination geographic location can be recommended. However, if there is a large amount of vehicular traffic, visiting the destination geographic location may not be recommended.

In some cases, the multiple data items include geographic location data (e.g., obtained via a global positioning system (GPS) receiver) and motion data (e.g., speed and direction of motion) from mobile devices, and a type of movement (e.g., a path traveled or a vehicle used (determined, for example, based on speed) can be determined from the multiple data items. In these cases, a determination that an outdoor activity is being conducted at a geographic location can be made based on the multiple data items. For example, if the outdoor activity is hiking, determining, based on the multiple data items, that the outdoor activity is available in the destination geographic location can include determining that at least a portion of the multiple data items correspond to travelling at a hiking speed (e.g., 5-7 kilometers per hour) along a predetermined trail (e.g., a hiking trail). If the outdoor activity is biking, determining, based on the multiple data items, that the outdoor activity is available in the destination geographic location can include determining that at least a portion of the multiple data items correspond to travelling at a biking speed (e.g., 25-35 kilometers per hour) along a predetermined trail (e.g., a biking trail). If the outdoor activity is strolling or picnicking, determining, based on the multiple data items, that the outdoor activity is available in the destination geographic location can include determining that at least a portion of the multiple data items correspond to remaining still or travelling at a strolling speed (e.g., 3-5 kilometers per hour), where the travelling is not along a predetermined trail (e.g., strolling around a meadow without defined trails instead of hiking along a hiking trail). If the outdoor activity is playing a sports game (e.g., American soccer, American football, baseball, basketball, or tag), determining, based on the multiple data items, that the outdoor activity is available in the destination geographic location can include determining that at least a portion of the multiple data items correspond to travelling at a speed associated with the sports game (e.g., a running speed, e.g., 7-12 kilometers per hour, in a sports game that involves running), where the travelling may, in some cases, not be along a predetermined trail.

In step 640, the server provides, to the client computing device, an indication that the outdoor activity is available in the destination geographic location. After step 640, the process 600 ends.

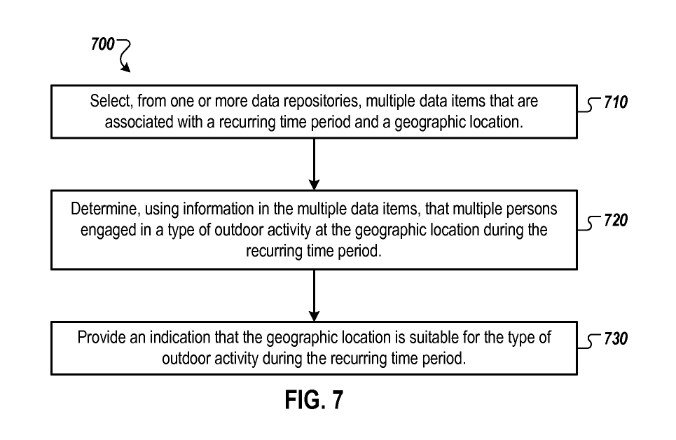

FIG. 7 illustrates an example process 700 by which a geographic location may be determined to be suitable for an outdoor activity.

The process 700 begins at step 710 where a server (e.g., server 120, via operation of the location/activity suitability module 308) selects, from one or more data repositories (e.g., the social data store 130 with content items 408.1-n, the geographic data store 140 with location data 508.1-n, or one or more other data stores with data items), multiple data items that are associated with a recurring time period (e.g., have a timestamp within the recurring time period) and a geographic location (e.g., have a geocode within the geographic location, where the geographic location is defined by a border, for example, a region on a map, e.g., Golden Gate Park occupies a region on a map of San Francisco, Calif., that can be defined by a border).

In step 720, the server determines, using information in the multiple data items, that multiple persons engaged in a type of outdoor activity (e.g., hiking, biking, strolling, picnicking, or playing a sports game) at the geographic location during the recurring time period. The determination can be made by analyzing the multiple data items, for example, photographs can include images or comments indicating that people are engaging in the type of outdoor activity. Alternatively, motion data can indicate that people are moving at speeds associated with the type of outdoor activity and/or along travel paths associated with the type of outdoor activity. For example, if the outdoor activity is hiking, the data items can indicate that people move along certain paths (e.g., hiking trails) at walking speeds.

In step 730, the server provides, for example, by transmitting data via a network, an indication that the geographic location is suitable for the type of outdoor activity during the recurring time period. The indication can be provided to a client computing device (e.g., client computing device 110) that is requesting information about outdoor activity geographic locations. The indication can be provided to a data storage unit (e.g., for storing among the location data 516.1-n in the geographic data store 140) for storing information about outdoor activities at geographic locations, possibly in conjunction with other geographic data. After step 730, the process 700 ends.

In some implementations, a popularity score can be provided to measure how popular the geographic location is during the recurring time period (or another time period). For example, a city park may have a larger number of visitors on weekends than on weekdays, a ski resort may have a larger number of visitors during the winter than during the summer, and a campground may have a larger number of visitors during the summer than during the winter. In some examples, S(t) may represent a number of user interactions per unit time (e.g., hour) for the geographic location. For a time period t₁ . . . t₂, the popularity score can correspond to the sum of S(t₁) . . . S(t₂) divided by the average S(t) for the location and divided by the number of units of time between t₁ and t₂.

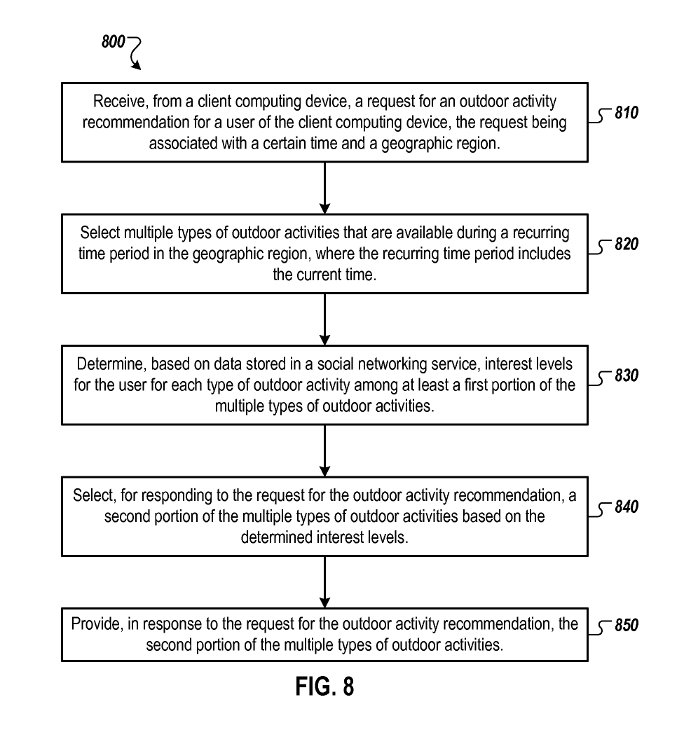

FIG. 8 illustrates an example process 800 by which information about available types of outdoor activities may be provided.

The process 800 begins at step 810, where a server (e.g., server 120, via operation of the recommend activity module 310) receives, from a client computing device (e.g., client computing device 110), a request for an outdoor activity recommendation for a user of the client computing device. The request is associated with a certain time (e.g., the current time, or a time specified by the user of the client computing device) and a geographic region (e.g., within a threshold radius, e.g., 100 kilometers, of a current geographic location of the client computing device, within the threshold radius of a geographic location specified by the user of the client computing device, or within a geographic area (e.g., a municipality, a county, a state, etc.) specified by the user of the client computing device).

In step 820, the server selects multiple types of outdoor activities that are available during a recurring time period (e.g., a current month of the year) in the geographic region. The recurring time period includes the current time. The types of outdoor activities can include hiking, biking, swimming, scuba diving, picnicking, strolling, playing a sports game, etc. The server can determine that multiple types of outdoor activities are available during the recurring time period in the geographic region based on information stored in one or more data repository (e.g., social data store 130, geographic data store 140, or other data store(s)).

In step 830, the server determines, based on data stored in a social networking service (e.g., data in the social data store 130), interest levels for the user for each type of outdoor activity among at least a first portion of the multiple types of outdoor activities. The user can indicate to the social networking service (e.g., in specifying the user's interests when registering for the social networking service) that he/she is interested in certain type(s) of outdoor activities. Alternatively, the user's interests can be determined automatically based on the user's membership in social network group(s) dedicated to type(s) of outdoor activities or based on the user's social contacts having indicated their interest in type(s) of outdoor activities.

In step 840, the server selects, for responding to the request for the outdoor activity recommendation, a second portion of the multiple types of outdoor activities based on the determined interest levels.

In step 850, the server provides, to the client computing device, in response to the request for the outdoor activity recommendation, indicia of the second portion of the multiple types of outdoor activity. After step 850, the process 800 ends.

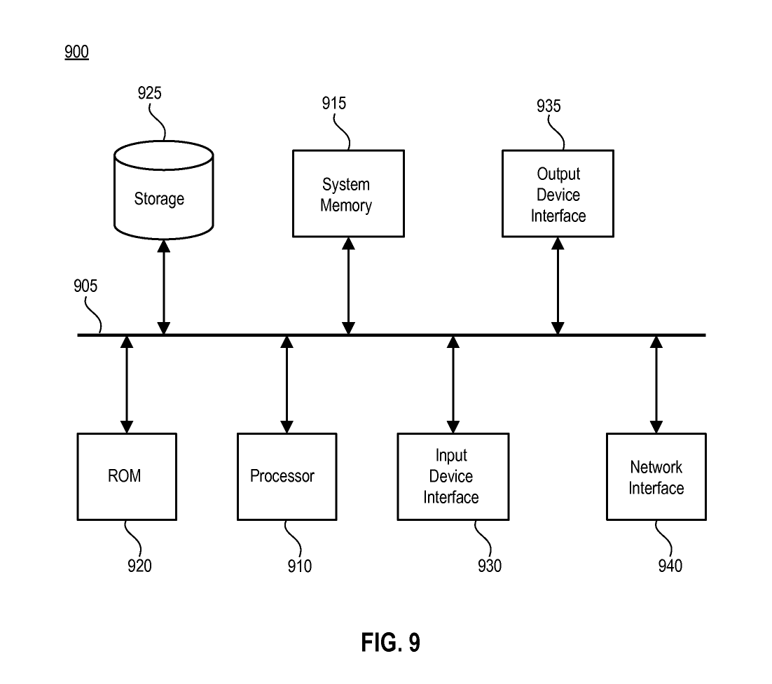

FIG. 9 conceptually illustrates an electronic system 900 with which some implementations of the subject technology are implemented. For example, one or more of the social data store 130, the geographic data store 140, the server 120, or the client computing device 110 may be implemented using the arrangement of the electronic system 900. The electronic system 900 can be a computer (e.g., a mobile phone, PDA), or any other sort of electronic device. Such an electronic system includes various types of computer readable media and interfaces for various other types of computer readable media. Electronic system 900 includes a bus 905, processing unit(s) 910, a system memory 915, a read-only memory 920, a permanent storage device 925, an input device interface 930, an output device interface 935, and a network interface 940.

The bus 905 collectively represents all system, peripheral, and chipset buses that communicatively connect the numerous internal devices of the electronic system 900. For instance, the bus 905 communicatively connects the processing unit(s) 910 with the read-only memory 920, the system memory 915, and the permanent storage device 925.

From these various memory units, the processing unit(s) 910 retrieves instructions to execute and data to process in order to execute the processes of the subject technology. The processing unit(s) can be a single processor or a multi-core processor in different implementations.

The read-only-memory (ROM) 920 stores static data and instructions that are needed by the processing unit(s) 910 and other modules of the electronic system. The permanent storage device 925, on the other hand, is a read-and-write memory device. This device is a non-volatile memory unit that stores instructions and data even when the electronic system 900 is off. Some implementations of the subject technology use a mass-storage device (for example a magnetic or optical disk and its corresponding disk drive) as the permanent storage device 925.

Other implementations use a removable storage device (for example a floppy disk, flash drive, and its corresponding disk drive) as the permanent storage device 925. Like the permanent storage device 925, the system memory 915 is a read-and-write memory device. However, unlike storage device 925, the system memory 915 is a volatile read-and-write memory, such a random access memory. The system memory 915 stores some of the instructions and data that the processor needs at runtime. In some implementations, the processes of the subject technology are stored in the system memory 915, the permanent storage device 925, or the read-only memory 920. For example, the various memory units include instructions for recommending an outdoor activity using a geographic information system in accordance with some implementations. From these various memory units, the processing unit(s) 910 retrieves instructions to execute and data to process in order to execute the processes of some implementations.

The bus 905 also connects to the input and output device interfaces 930 and 935. The input device interface 930 enables the user to communicate information and select commands to the electronic system. Input devices used with input device interface 930 include, for example, alphanumeric keyboards and pointing devices (also called “cursor control devices”). Output device interfaces 935 enables, for example, the display of images generated by the electronic system 900. Output devices used with output device interface 935 include, for example, printers and display devices, for example cathode ray tubes (CRT) or liquid crystal displays (LCD). Some implementations include devices for example a touch screen that functions as both input and output devices.

Finally, as shown in FIG. 9, bus 905 also couples electronic system 900 to a network (not shown) through a network interface 940. In this manner, the electronic system 900 can be a part of a network of computers (for example a local area network (“LAN”), a wide area network (“WAN”), or an Intranet, or a network of networks, for example the Internet. Any or all components of electronic system 900 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A computer-implemented method for recommending an outdoor activity geographic location, the method comprising:
selecting, from one or more data repositories, a plurality of data items that are associated with a recurring time period and a destination geographic location;
determining, using information in the selected plurality of data items and at least one characteristic of a user of a client computing device, that an outdoor activity for the user is available in the destination geographic location during the recurring time period; and
providing, to the client computing device, an indication that the outdoor activity is available in the destination geographic location.

2. The method of claim 1, further comprising:
receiving, from the client computing device, a request for an outdoor activity geographic location recommendation.

3. The method of claim 1, further comprising:
receiving, from the client computing device, an indication of a geographic location of the client computing device; and
selecting the destination geographic location based on a proximity of the destination geographic location to the geographic location of the client computing device.

4. The method of claim 1, wherein the outdoor activity comprises hiking, and wherein determining, using information in the selected plurality of data items, that the outdoor activity is available in the destination geographic location during the recurring time period comprises:
determining that at least a portion of the selected plurality of data items correspond to travelling at a hiking speed range along a predetermined trail.

5. The method of claim 1, wherein the outdoor activity comprises biking, and wherein determining, using information in the selected plurality of data items, that the outdoor activity is available in the destination geographic location during the recurring time period comprises:
determining that at least a portion of the selected plurality of data items correspond to travelling at a biking speed range along a predetermined trail.

6. The method of claim 1, wherein the outdoor activity comprises strolling or picnicking, and wherein determining, using information in the selected plurality of data items, that the outdoor activity is available in the destination geographic location during the recurring time period comprises:
determining that at least a portion of the selected plurality of data items correspond to remaining still or travelling at a strolling speed, wherein the travelling is not along a predetermined trail.

7. The method of claim 1, wherein the outdoor activity comprises playing a sports game, and wherein determining, using information in the selected plurality of data items, that the outdoor activity is available in the destination geographic location during the recurring time period comprises:
determining that at least a portion of the selected plurality of data items correspond to travelling at a speed associated with the sports game, wherein the travelling is not along a predetermined trail.

8. The method of claim 1, wherein the at least one characteristic of the user of a client computing device comprises at least one of a geographic location of the user, an interest level of the user in the outdoor activity, an age of the user, a gender of the user, a fitness level of the user, a desired activity strenuousness level of the user, or an age of a child participating in the activity with the user.

9. A non-transitory computer-readable medium comprising instructions which, when executed by one or more computers, cause the one or more computers to implement a method, the method comprising:
selecting, from one or more data repositories, a plurality of data items that are associated with the recurring time period and a geographic location;
determining, using information in the selected plurality of data items, that a plurality of persons engaged in the type of outdoor activity at the geographic location during the recurring time period; and
providing an indication that the geographic location is suitable for the type of outdoor activity during the recurring time period.

10. The computer-readable medium of claim 9, wherein the indication that the geographic location is suitable for the type of outdoor activity during the recurring time period is provided to a client computing device.

11. The computer-readable medium of claim 9, wherein the indication that the geographic location is suitable for the type of outdoor activity during the recurring time period is provided for storage in a data storage unit.

12. The computer-readable medium of claim 9, wherein the plurality of data items comprise a predicted number of people visiting the geographic location during a specified time within the recurring time period.

13. The computer-readable medium of claim 9, wherein the plurality of data items comprises a number of photographs taken in the geographic location during the recurring time period.

14. The computer-readable medium of claim 9, wherein the plurality of data items comprises a number of interactions with photographs taken in the geographic location during the recurring time period, wherein the interactions occurred via a social networking or photograph sharing service, and wherein the interactions comprise re-sharing a photograph, indicating a preference for a photograph, or commenting on a photograph.

15. The computer-readable medium of claim 9, wherein the plurality of data items comprise an age range, a gender, or a fitness level of people visiting the geographic location during the recurring time period.

16. The computer-readable medium of claim 9, wherein the plurality of data items comprise a type of scenery at the geographic location during the recurring time period.

17. A system comprising:
one or more processors; and
a memory comprising instructions which, when executed by the one or more processors, cause the one or more computers to implement a method, the method comprising:
receiving, from a client computing device, a request for an outdoor activity recommendation for a user of the client computing device, the request being associated with a certain time and a geographic region;
selecting a plurality of types of outdoor activities that are available during a recurring time period in the geographic region, wherein the recurring time period comprises the current time;
determining, based on data stored in a social networking service, interest levels for the user for each type of outdoor activity among at least a first portion of the plurality of types of outdoor activities;
selecting, for responding to the request for the outdoor activity recommendation, at least a second portion of the plurality of types of outdoor activities based on the determined interest levels; and
providing, in response to the request for the outdoor activity recommendation, the at least the second portion of the plurality of types of outdoor activities.

18. The system of claim 17, wherein the geographic region comprises a region within a threshold radius of a geographic location of the client computing device.

19. The system of claim 17, wherein the geographic region comprises a region within a threshold radius of a geographic location specified by the user of the client computing device.

20. The system of claim 17, wherein the recurring time period comprises a time period that recurs once per year.

21. The system of claim 17, wherein the recurring time period comprises a time period beginning a threshold number of days before the current time and ending the threshold number of days after the current time.
